(19) United States
(12) Patent Application Publication
(10) Pub. No.: US 2006/0026418 A1
(43) Pub. Date: Feb. 2, 2006

(54) Method, apparatus, and product for providing a multi-tiered trust architecture

(75) Inventors: Steven A. Bade, Georgetown, TX (US); Ryan Charles Catherman, Raleigh, NC (US); James Patrick Hoff, Raleigh, NC (US); Nia Letise Kelley, Austin, TX (US); Emily Jane Ratliff, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/902,669

(22) Filed: Jul. 29, 2004

(51) Int. Cl. H04L 9/00

(52) U.S. Cl. 713/150

(57) ABSTRACT

A method, apparatus, and computer program product are described for implementing a trusted computing environment within a data processing system. The data processing system includes multiple different service processor-based hardware platforms. Multiple different trusted platform modules (TPMs) are provided in the data processing system. Each TPM provides trust services to only one of the service processor-based hardware platforms. Each TPM provides its trust services to only a portion of the entire data processing system.

### CROSS-REFERENCE TO RELATED APPLICATIONS

The subject matter of the present invention is related to the subject matter of co-pending United States patent applications: Ser. No. ______, entitled METHOD, APPARATUS, AND PRODUCT FOR ASSERTING PHYSICAL PRESENCE WITH A TRUSTED PLATFORM MODULE IN A HYPERVISOR ENVIRONMENT, attorney docket number AUS920040171US1; Ser. No. ______, entitled METHOD, APPARATUS, AND PRODUCT FOR PROVIDING A SCALABLE TRUSTED PLATFORM MODULE IN A HYPERVISOR ENVIRONMENT, attorney docket number AUS920040172US1; and Ser. No. ______, entitled METHOD, APPARATUS, AND PRODUCT FOR PROVIDING A BACKUP HARDWARE TRUSTED PLATFORM MODULE IN A HYPERVISOR ENVIRONMENT, attorney docket number AUS920040188US1, all filed on the same date herewith, assigned to the same assignee, and incorporated herein in its entirety by reference.

### BACKGROUND OF THE INVENTION

1. Field of the Invention

The present invention relates to an improved data processing system and, in particular, to a method, apparatus, and product for data storage protection using cryptography. Still more particularly, the present invention relates to a method, apparatus, and computer program product in an environment that provides a multi-tiered trust architecture that uses multiple trusted platform modules such that one hardware TPM provides trust services for only a portion of the environment.

2. Description of Related Art

Most data processing systems contain sensitive data and sensitive operations that need to be protected. For example, the integrity of configuration information needs to be protected from illegitimate modification, while other information, such as a password file, needs to be protected from illegitimate disclosure. As another example, a data processing system needs to be able to reliably identify itself to other data processing systems.

An operator of a given data processing system may employ many different types of security mechanisms to protect the data processing system. For example, the operating system on the data processing system may provide various software mechanisms to protect sensitive data, such as various authentication and authorization schemes, while certain hardware devices and software applications may rely upon hardware mechanisms to protect sensitive data, such as hardware security tokens and biometric sensor devices.

The integrity of a data processing system's data and its operations, however, centers around the issue of trust. A data processing system's data and operations can be verified or accepted by another entity if that entity has some manner for establishing trust with the data processing system with respect to particular data items or particular operations.

Hence, the ability to protect a data processing system is limited by the manner in which trust is created or rooted within the data processing system. To address the issues of protecting data processing systems, a consortium of companies has formed the Trusted Computing Group (TCG) to develop and to promulgate open standards and specifications for trusted computing. According to the specifications of the Trusted Computing Group, trust within a given data processing system or trust between a data processing system and another entity is based on the existence of a hardware component within the data processing system that has been termed the trusted platform module (TPM).

A trusted platform enables an entity to determine the state of the software environment in that platform and to seal data to a particular software environment in that platform. The entity deduces whether the state of the computing environment in that platform is acceptable before performing a transaction with that platform. To enable this, the trusted platform provides integrity metrics, also known as integrity measurements, to the entity that reflect the integrity of the software state of the trusted platform. The integrity measurements require a root of trust within the computing platform. In order for a system to be a trusted platform, the integrity measurements must be taken from the Core Root of Trust for Measurements and extended through the initial program load (IPL) process up to the point at which the operating system is initialized.

A trusted platform module has been generally described in a platform-independent manner, but platform-specific descriptions have been created for certain classes of systems, such as personal computers (PCs). Existing hardware for trusted computing has focused on implementations for a single hardware trusted platform module that provides trust services for the entire system. This situation is sufficient for simple servers and PCs, which tend to be relatively low-performance computers that meet the needs of stand-alone computational environments or client-side processing environments.

Thus, known systems use a single hardware TPM to provide trust services to the entire system. One hardware TPM is designed to provide support for a single, non-partitionable computer system. Thus, existing systems utilize a single hardware TPM to provide trust for the entire single system.

High-performance servers, though, support partitionable, multithreaded environments that may need access to a trusted platform module on multiple threads simultaneously. This type of environment allocates, or partitions, physical resources to each of the supported multiple partitions. In addition, each partition can be thought of as a separate logical computer system that can execute its own operating system and applications. The operating system executed by one partition may be different from the operating systems being executed by the other partitions.

These high-performance data processing systems may include more than one processor, such as by providing a service processor in addition to the processors that are allocated to partitions, that is essentially its own platform separate from the logical partitions and separate from the processors that are used to support those logical partitions. The service processor executes its own operating system in its own environment. Therefore, there can be two, three, or more platforms in a single data processing system. In these systems, the single hardware TPM would be required to provide trust to each of these different platforms including the logical platforms and each different service processor platform.

Therefore, it would be advantageous to have a mechanism, in a data processing system that includes multiple different platforms, that provides separate trust services to each partition by providing a dedicated hardware TPM to each platform.

### SUMMARY OF THE INVENTION

A method, apparatus, and computer program product are described for implementing a trusted computing environment within a data processing system. The data processing system includes multiple different service processor-based hardware platforms. Multiple different hardware trusted platform modules (TPMs) are provided in the data processing system. Each TPM provides trust services to only one of the service processor-based hardware platforms. Thus, each TPM provides its trust services to only a portion of the entire data processing system.

A hypervisor is initialized within the data processing system, and the hypervisor supervises a plurality of logical, partitionable, runtime environments within the data processing system. The hypervisor reserves a logical partition for a hypervisor-based trusted platform module (TPM) and presents the hypervisor-based trusted platform module to other logical partitions as a virtual device via a device interface. Each time that the hypervisor creates a logical partition within the data processing system, the hypervisor also instantiates a logical TPM for that partition. The hypervisor manages multiple logical TPMs within the reserved host partition such that each logical TPM is uniquely associated with a logical partition. Thus, the hypervisor-based TPM provides trust services to each logical partition, while each hardware TPM provides trust to only one service processor-based hardware platform.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may be used to implement the present invention;

FIG. 1B depicts a computer architecture in accordance with the prior art;

FIG. 1C depicts a block diagram a data processing system in accordance with the prior art;

FIG. 1D is a block diagram that illustrates a data processing system that includes multiple different platforms, including service processor-based hardware platforms and a system platform, in accordance with the present invention;

FIG. 2 is a block diagram of a modified trusted platform architecture in accordance with the present invention;

FIG. 3 depicts a block diagram that illustrates a modified trusted platform module (TPM) according to the present invention;

FIG. 4 is a block diagram that depicts a data processing system that includes a separate TPM for each platform in accordance with the present invention;

FIG. 5 depicts a high level flow chart that illustrates storing digital signatures and hashed values of those signatures in a service processor in accordance with the present invention;

FIG. 6 illustrates a high level flow chart that depicts a service processor authenticating the TPM that is included within the service processor, and the TPM providing trust services to only that service processor in accordance with the present invention; and

FIG. 7 depicts a high level flow chart that illustrates booting service processors and authenticating TPMs such that a TPM provides trust services just to the service processor in which the TPM is included in accordance with the present invention.

### DETAILED DESCRIPTION OF THE INVENTION

The present invention is a method, apparatus, and computer program product that provides different tiers of trust to a data processing system. The data processing system is an environment that includes two or more service processors. Each service processor can be thought of as its own separate hardware platform executing its own separate operating system. Thus, the data processing system includes a primary platform that may be logically partitioned and other multiple different platforms such as service processor platforms. According to the present invention, each service processor will have its own dedicated hardware TPM that will provide trust services to only that service processor. Another TPM exists in the data processing system, either in hardware or software, that provides trust services to the platform that supports the logical partitions.

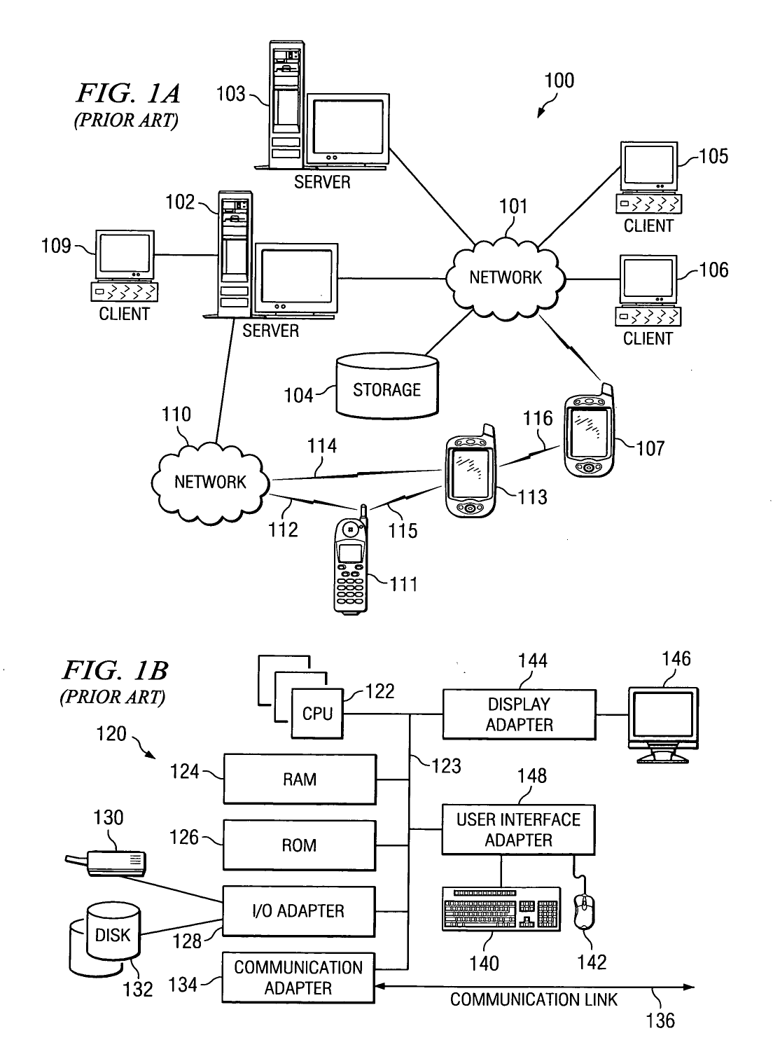

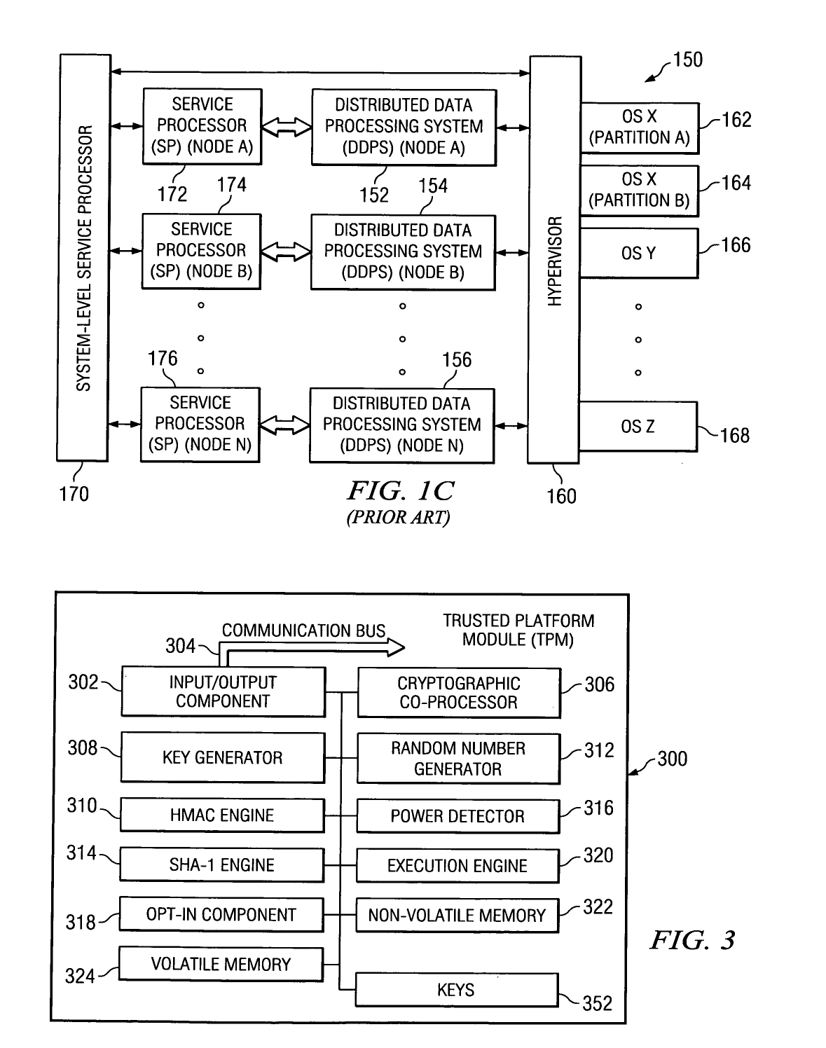

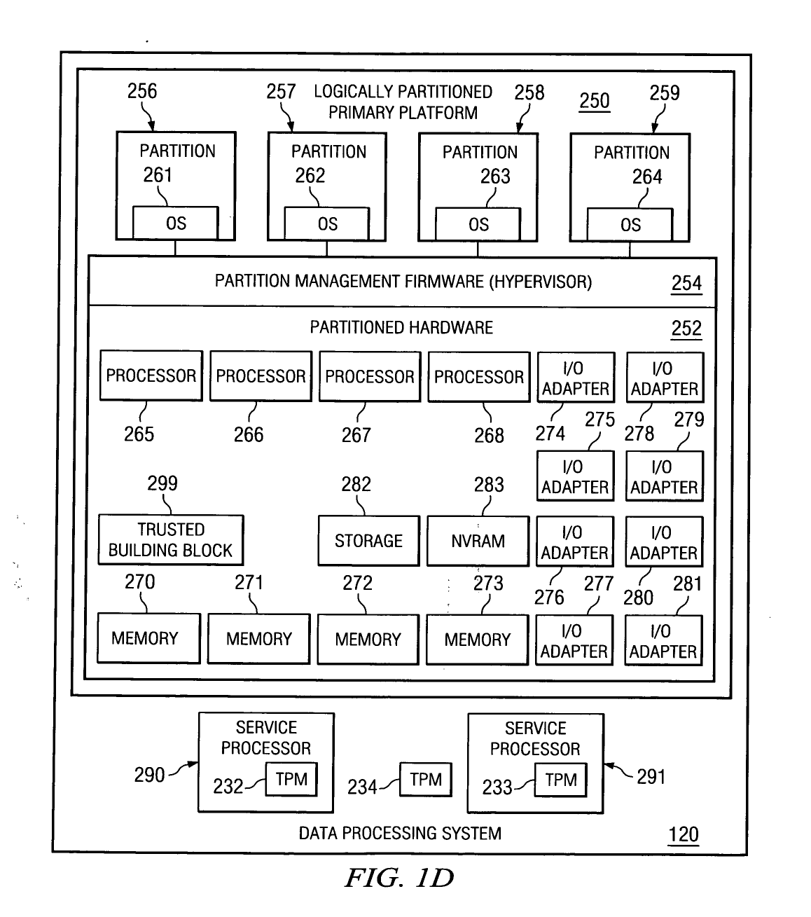

FIG. 1A depicts a network of data processing systems, each of which may be used to implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

FIG. 1B depicts a computer architecture according to the prior art that in which the present invention may be included. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

FIG. 1C depicts a distributed data processing system in accordance with the prior art in which the present invention may be included. Distributed data processing system 150 contains multiple nodes 152-156, each of which may represent a single-processor or multi-processor device or card connected to a communication switch or a network; nodes 152-156 may be implemented as central electronic complex (CEC) units. Hypervisor 160 supports multiple instances of one or more operating systems and/or operating system partitions 162-168 on the shared computational resources of the distributed data processing nodes of system 150. Hypervisor 160 communicates with system-level service processor 170, which is responsible for booting system 150 and for monitoring the availability of the shared resources. Each distributed data processing node is associated with at least one service processor, e.g., service processors 172-176, each of which is responsible for booting its associated node and for assisting system-level service processor 170 in monitoring each of the nodes; a service processor may be associated with a node through a variety of physical connections to its associated node, e.g., the service processor's hardware card may attach to a PCI bus. It should be noted that each node may have a plurality of service processors, although only one service processor would be responsible for booting its associated node.

The present invention could be implemented on a variety of hardware platforms and computational environments; FIG. 1A, FIG. 1B, and FIG. 1C are intended as examples of a heterogeneous computing environment and not as architectural limitations for the present invention.

In addition to being able to be implemented on a variety of hardware platforms and computational environments, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above. More specifically, though, the present invention is directed to trusted computing platforms.

FIG. 1D is a block diagram of a logically partitioned primary platform that includes the present invention. Logically partitioned primary platform 250 includes partitioned hardware 252, partition management firmware, also called a hypervisor 254, and partitions 256-259. Operating systems 261-264 exist within partitions 256-259. Operating systems 261-264 may be multiple copies of a single operating system or multiple heterogeneous operating systems simultaneously run on platform 250.

Partitioned hardware 252 includes a plurality of processors 265-268, a plurality of system memory units 270-273, a plurality of input/output (I/O) adapters 274-281, and a storage unit 282. Each of the processors 265-268, memory units 270-273, NVRAM storage 283, and I/O adapters 274-281 may be assigned to one of multiple partitions 256-259.

Hypervisor 254 is responsible for partitioning the primary platform 250. Partition management firmware (hypervisor) 254 performs a number of functions and services for partitions 256-259 to create and enforce the partitioning of logically partitioned primary platform 250. Hypervisor 254 is a firmware implemented virtual machine identical to the underlying hardware. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and non-volatile random access memory (non-volatile RAM). Thus, hypervisor 254 allows the simultaneous execution of independent OS images 261-264 by virtualizing all the hardware resources of logically partitioned platform 250. Hypervisor 254 may attach I/O devices through I/O adapters 274-281 to single virtual machines in an exclusive mode for use by one of OS images 261-264.

Data processing system 120 includes multiple different service processors. Each service processor is a separate hardware partition within system 120 that executes its own operating system. According to the present invention, a hardware TPM is included in each service processor. For example, service processor 290 includes TPM 232, and service processor 291 includes TPM 233. In addition, a backup hardware TPM 234 that may be utilized to functionally replace either TPM 232 or 234 if TPM 232 or 234 is malfunctioning.

A trusted building block 299, which includes one or more hardware trusted platform modules may also be included within platform 250.

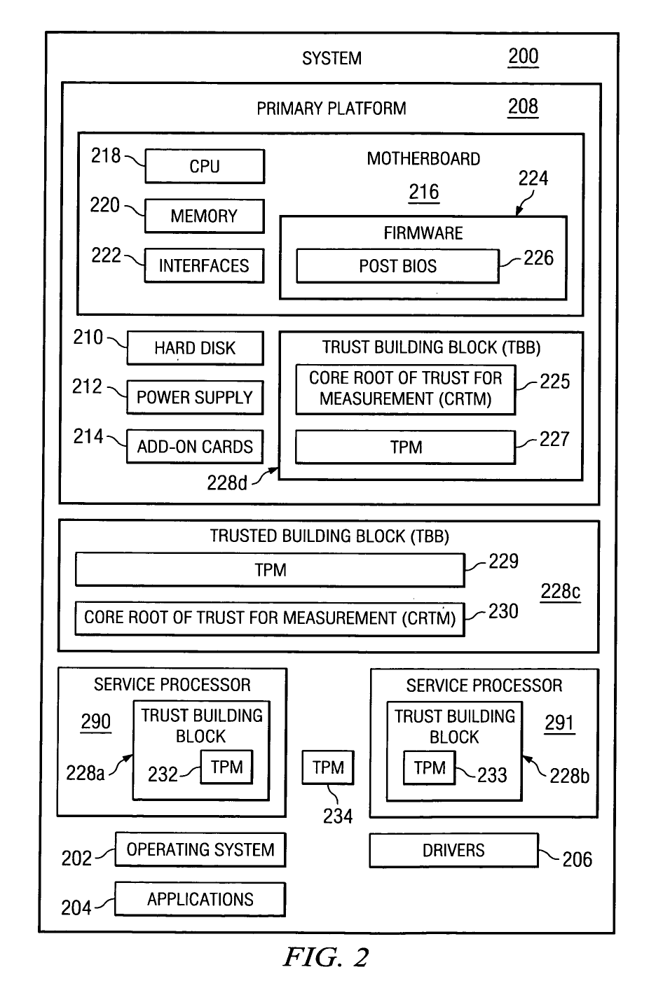

FIG. 2 depicts a trusted platform architecture that has been modified according to the present invention. Except as noted below with regard to the present invention, the remaining components of the TPM operate in accordance with the TCG's PC-specific implementation specification.

System 200 supports execution of software components, such as operating system 202, applications 204, and drivers 206, on its primary platform 208. System 200 also includes service processor 290, service processor 291, backup TPM 234, and may include a separate trusted building block (TBB) 228c. Service processor 290 is a separate hardware platform. Service processor 291 is also a separate hardware platform.

Each service processor includes its own TBB which in turn includes a hardware TPM. For example, processor 290 includes TBB 228a which includes TPM 232. Service processor 291 includes TBB 228b which includes TPM 233.

A TBB comprises the combination of the core root of trust for measurement (CRTM) component, a trusted platform module (TPM), the connection of the CRTM to motherboard, and the connection of the TPM to motherboard. For example, TBB 228c includes TPM 229 and CRTM 230; and TBB 228d includes TPM 227 and CRTM 225.

Each TBB provides trust to one of the platforms of system 200. Each TBB includes its own CRTM. A CRTM is an immutable portion of a platform's initialization code that executes upon a platform reset. This is the platform for which the TBB that includes the CRTM provides its services.

The platform's execution must begin at the CRTM upon any platform reset event. In this manner, the trust in the platform is based on the CRTM and the behavior of the TPM, and the trust in all measurements is based on the integrity of the CRTM.

For example, the BIOS may be assumed to include a BIOS Boot Block and POST BIOS 226; each of these are independent components that can be updated independent of each other, wherein the manufacturer must control the update, modification, and maintenance of the BIOS Boot Block, but a third party supplier may update, modify, or maintain the POST BIOS component. In the example that is shown in FIG. 2, CRTM 225 may be assumed to be the BIOS Boot Block, and the POST BIOS is a measured component of the chain of trust. Alternatively, the CRTM may comprise the entire BIOS.

The software components may be received through a network, such as network 101 that is shown in FIG. 1A, or they may be stored, e.g., on hard disk 210. Platform 208 receives electrical power from power supply 212 for executing the software components on add-on cards 214 and motherboard 216, which includes typical components for executing software, such as CPU 218 and memory 220, although motherboard 216 may include multiple CPUs. Interfaces 222 connect motherboard 216 to other hardware components within system 200, and firmware 224 contains POST BIOS (power-on self-test basic input/output system) 226.

Motherboard 216 may also comprise another trusted building block (TBB) 228d; motherboard 216 is supplied by a manufacturer with TBB 228d and other components physically or logically attached and supplied by the manufacturer.

FIG. 3 depicts a block diagram that illustrates a trusted platform module (TPM) that may be utilized to implement any of the TPMs described herein in accordance with the present invention.

Trusted platform module 300 comprises input/output component 302, which manages information flow over communications bus 304 by performing appropriate protocol encoding/decoding operations and routing of messages to appropriate components. Cryptographic co-processor 306 performs cryptographic operations within a trusted platform module. Key generator 308 creates symmetric keys and RSA asymmetric cryptographic key pairs. HMAC engine 310 performs HMAC (Keyed-Hashing for Message Authentication) calculations, whereby message authentication codes are computed using secret keys as integrity checks to validate information transmitted between two parties, e.g., in accordance with Krawczyk et al., “HMAC: Keyed-Hashing for Message Authentication”, Request for Comments (RFC) 2104, Internet Engineering Task Force (IETF), February 1997.

Random number generator 312 acts as a source of randomness for the computation of various values, such as nonces, keys, or other values. SHA-1 engine 314 implements the SHA-1 hash algorithm. Power detector 316 manages the power states of a trusted platform module in association with the power states of the platform. Opt-in component 318 maintains the state of persistent and volatile flags and enforces semantics associated with those flags such that the trusted platform module may be enabled and disabled. Execution engine 320 runs program code to execute commands that the trust platform module receives through input/output component 302. Non-volatile memory 322 stores persistent identity and state associated with the trusted platform module; the non-volatile memory may store static data items but is also available for storing dynamic data items by entities that are authorized by the trusted platform module owner, whereas volatile memory 324 stores dynamic data items.

Encryption keys 352 are stored within TPM 300. Various encryption keys may be utilized by TPM 300 in order to authenticate another device and/or to communicate with another device. Although encryption keys 352 are depicted separately from the other components of the TPM, the various encryption keys will typically be stored in non-volatile memory 322. The encryption keys may include a private TPM endorsement key and a platform binding key. Other encryption keys may also be stored in keys 352.

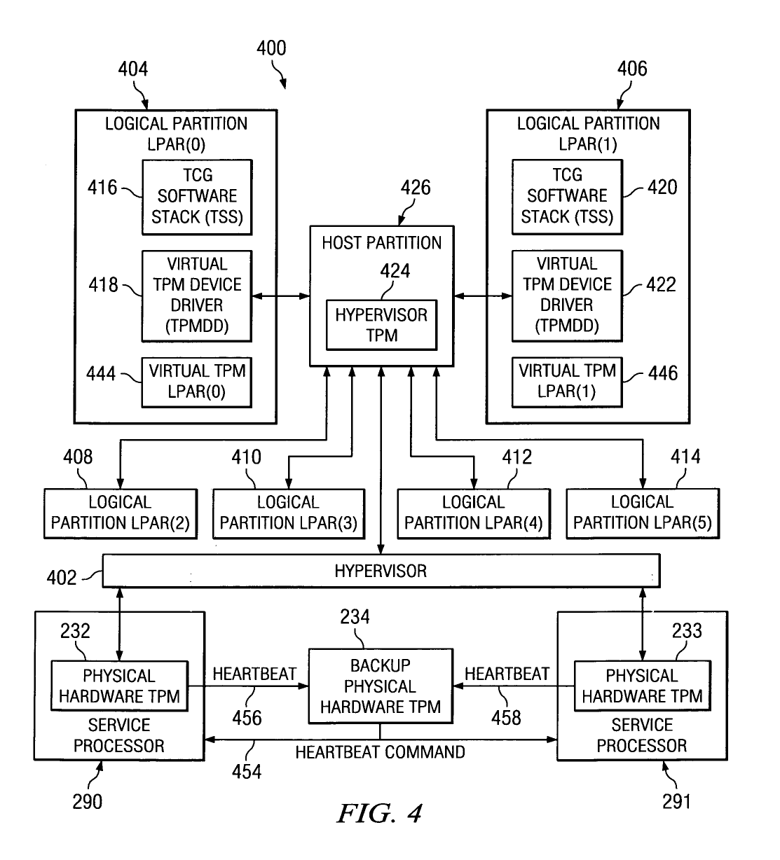

FIG. 4 is a block diagram that depicts a data processing system that includes a separate TPM for each platform in accordance with the present invention. Data processing system 400 contains a hypervisor 402 that supports multiple instances of one or more operating systems and/or logical partitions (LPARs) on the shared computational resources of data processing system 400. For example, hypervisor 402 supports LPARs 404, 406, 408, 410, 412, and 414.

Each LPAR includes a TCG software stack (TSS) and a TPM device driver (TPMDD). For example, LPAR 404 includes TSS 416 and TPMDD 418, while LPAR 406 includes TSS 420 and TPMDD 422. The other LPARs also include a TSS and TPMDD that are not depicted. TSS 416 and TSS 420 implement the specification of the host programming interfaces that an operating system, an application, or other software component utilizes to interface with a TPM. TSS comprises: the TSS service provider, to which an entity may interface via common application programming interfaces (APIs); the TSS core services, which provides centralized management of key storage, contexts, and handles the direct interaction with the TPM on the host; and the TPM device driver library and the TPMDD, such as TPMDD 418 or TPMDD 422. Generally, all interfacing to the TPM occurs through TSS service provider interface (TSPI) or an API above the TSPI.

Hypervisor 402 is firmware that is responsible for creating and enforcing the partitioning of platform 208 among the various partitions. Hypervisor 402 provides a set of firmware services to the operating system in each partition so that interference between operating system images is prevented. Each partition includes an operating system executing in that partition that may be the same as or different from the operating system that is executing in the other logical partitions. Hypervisor 402 manages the logical partitions, and allocates and manages the physical devices that are allocated to each partition.

Instead of assigning a hardware TPM to each logical partition, each logical partition will use a virtual TPM. Each virtual TPM is really an instance of a software based TPM within the hypervisor. For ease of management, the hypervisor TPM can be managed in a host partition. The concept of presenting virtual TPMs is a cost effective implementation, as it eliminates the amount of physical hardware TPMs required in the system; virtualization of a software TPM also allows for code reuse and ease of management.[0] Each partition may take advantage of a TPM's capabilities by accessing HTPM 424, which provides the functionality of a TPM for system 400. Thus, HTPM 424 provides a virtual TPM for system 400.

A TPM is specified as an I/O device with operations into it being asynchronous; in the present invention, HTPM 424 is represented as a virtual I/O device, i.e., a logical I/O device. Operations to the HTPM, e.g., functional calls or requests from one of the partitions, such as LPAR 404, to HTPM 424, are placed onto an input queue (not shown) included in hypervisor 402, which causes a trap into hypervisor 402. Hypervisor 402 re-queues the operation to HTPM 424, where the TPM functions are performed on a first-in, first-out basis. When the TPM function is complete, HTPM 424 places the results on an output queue (not shown) which also causes a trap into hypervisor 402; hypervisor 402 then passes the results back to the calling entity.

In an alternative embodiment, HTPM 424 could be implemented within hypervisor 402. In a preferred embodiment, HTPM 424 is managed by hypervisor 402 within a host logical partition, shown as Host partition 426, which is logically part of the hypervisor, e.g., its code is maintained as part of the certified hypervisor; the hypervisor creates Host partition 426 upon each reboot.

Managing the HTPM in a separate partition provides additional advantages. Many of the TPM operations utilize the RSA algorithm, which is computationally expensive, and the incorporation of the HTPM within the hypervisor would result in execution path lengths that would be unacceptable. Hence, by placing the HTPM within a partition, such as host partition 426, hypervisor 402 maintains its execution characteristics while relegating the TPM functions to a lower priority. Moreover, the placement of the HTPM in a separate partition provides the hypervisor with greater flexibility in protecting the memory that is used by the HTPM without impacting the hypervisor.

When the hypervisor creates a logical partition, the hypervisor instantiates a logical TPM for that partition. For example, the hypervisor instantiated logical, also called virtual, TPM 444 for LPAR(0). The hypervisor instantiated logical TPM 446 for LPAR(1).

When the hypervisor terminates a logical partition, the hypervisor destroys the partition's associated logical TPM (LTPM). Each LPAR within system 400 is uniquely associated with an LTPM, each of which is anchored to HTPM 416.

According to the present invention, each service processor includes its own hardware TPM. A service processor's TPM provides trust services to just that service processor. TPM 232 provides its trust services to service processor 290 and no other device, platform, system, or processor. TPM 233 provides its trust services to service processor 291 and no other device, platform, system, or processor.

TPM 234 is used as a backup TPM that monitors the health of TPMs 232-233 by transmitting a heartbeat command 454 periodically to TPMs 232-233. In response to receiving command 454, TPM 232 will respond by transmitting heartbeat 456 if TPM 232 is functioning properly, and TPM 233 will respond by transmitting heartbeat 456 if TPM 233 is functioning properly. If one of these TPMs is not functioning properly, TPM 234 will functionally replace the malfunctioning TPM in a manner such as described in co-pending application serial number ______ (Attorney Docket Number AUS920040171), filed ______, and entitled METHOD, APPARATUS, AND PRODUCT FOR ASSERTING PHYSICAL PRESENCE WITH A TRUSTED PLATFORM MODULE IN A HYPERVISOR ENVIRONMENT which is incorporated herein by reference in its entirety.

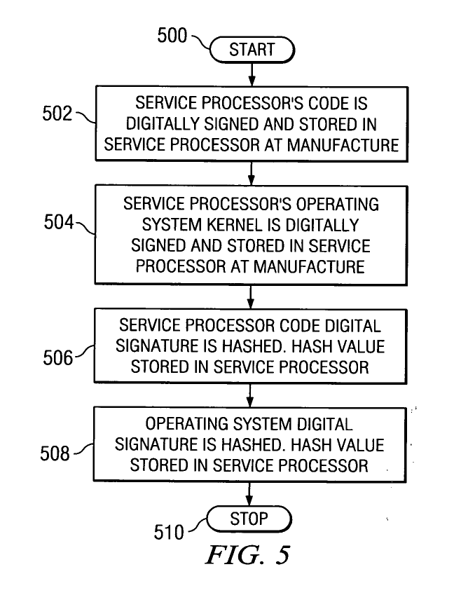

FIG. 5 depicts a high level flow chart that illustrates storing digital signatures and hashed values of those signatures in the service processor in accordance with the present invention. The process starts as depicted by block 500 and thereafter passes to block 502 which illustrates the service processor code itself being digitally signed and stored in the service processor at the time the service processor is manufactured. Next, block 504 illustrates a service processor's operating system kernel being digitally signed and stored in the service processor at the time the service processor is manufactured. Block 506, then, depicts the digital signature of the service processor code being hashed and stored in the service processor. The original hashed value will be stored in the service processor's TPM and within the service processor; it is later used for verification. Thereafter, block 508 illustrates the digital signature of the operating system being hashed and stored in the service processor. The original hashed value will be stored in the service processor's TPM and within the service processor; it is later used for verification. The hash values are computed either by a software hashing algorithm or by the service processor's TPM, strictly under the manufacturer's control. When the platform exist manufacturing, it has a stored digital signature and hash value, which will both be used later for verification purposes. The process then terminates as depicted by block 510.

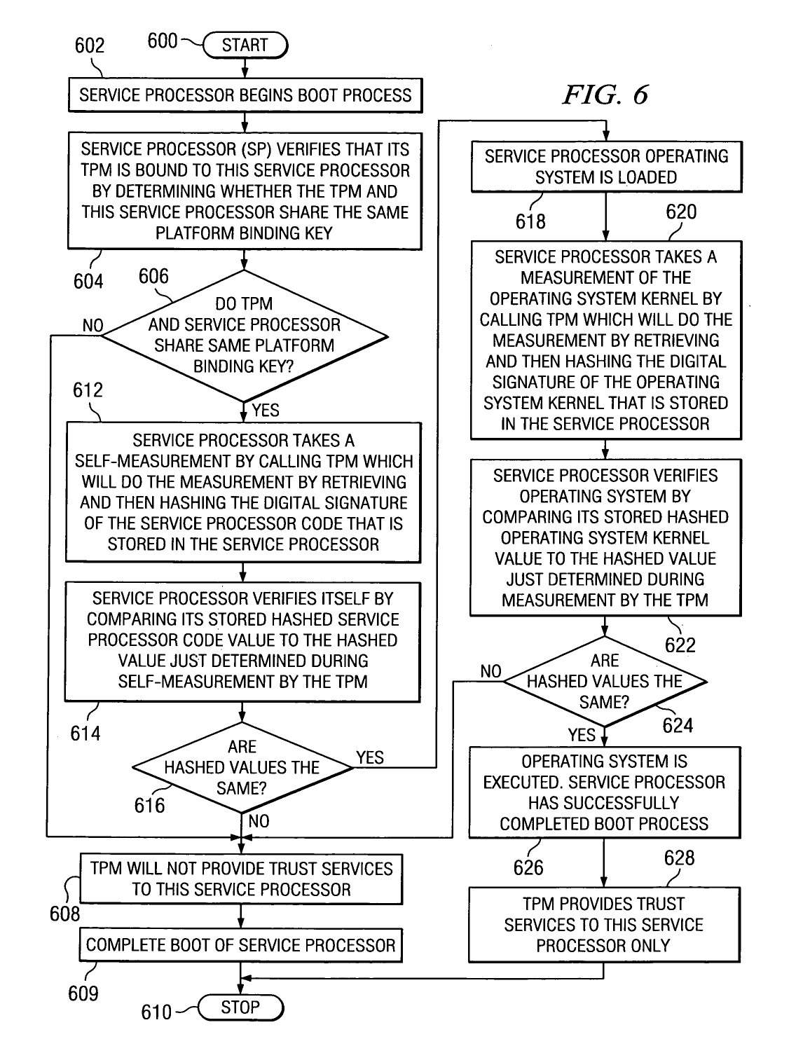

FIG. 6 illustrates a high level flow chart that depicts a service processor authenticating the TPM that is included within the service processor, and the TPM providing trust services to only that service processor in accordance with the present invention. The process starts as depicted by block 600 and thereafter passes to block 602 which illustrates a service processor (SP) beginning a boot process. Next, block 604 depicts the SP verifying that its TPM that is physically located within the SP is bound to this SP. The verification is executed by determining whether the TPM and the SP in which the TPM is located share the same platform binding key. The platform binding key was issued at manufacturing time, in accordance with the TCG specification.

Block 606, then, illustrates a determination of whether or not the TPM and SP share the same platform binding key. If a determination is made that the TPM and SP do not share the same platform binding key, the process passes to block 608 which depicts the TPM not being able to provide trust services to this SP. Next, block 609 depicts completing the booting of this service processor. The process then terminates as illustrated by block 610.

Referring again to block 606, if a determination is made that the TPM and SP do share the same platform binding key, the process passes to block 612 which illustrates the SP taking a self-measurement by calling the TPM that is included in the SP which will then execute the measurement by hashing the digital signature of the SP code that was stored in the SP at manufacture. The hash value is passed as a command input parameters to the TPM; the TPM does not have to explicitly retrieve the digital signature. Block 614, then, depicts the SP verifying itself by comparing its stored hashed SP code value to the hashed value just determined during the self-measurement by the TPM.

The process then passes to block 616 which illustrates the SP determining whether or not the hashed values are the same. If a determination is made that the hashed values are not the same, the process passes to block 608. Referring again to block 616, if a determination is made that the hashed values are the same, the process passes to block 618 which depicts the SP's operating system being loaded. Next, block 620 illustrates the SP taking a measurement of the SP's operating system (OS) kernel by calling the TPM which will execute the measurement. The TPM hashes the digital signature of the OS kernel that was stored in the SP at the time the SP was manufactured.

The process then passes to block 622 which depicts the SP verifying the OS by comparing its stored hashed OS kernel value to the hashed value just determined during measurement by the TPM. Next, block 624 illustrates a determination of whether or not the hashed values are the same. If a determination is made that the hashed values are not the same, the process passes to block 608. Referring again to block 624, if a determination is made that the hashed values are the same, the process passes to block 626 which depicts the SP's operating system being executed. The SP has now successfully completed the boot process. Next, block 628 illustrates the TPM providing trust services to only this SP. The process then terminates as depicted by block 610.

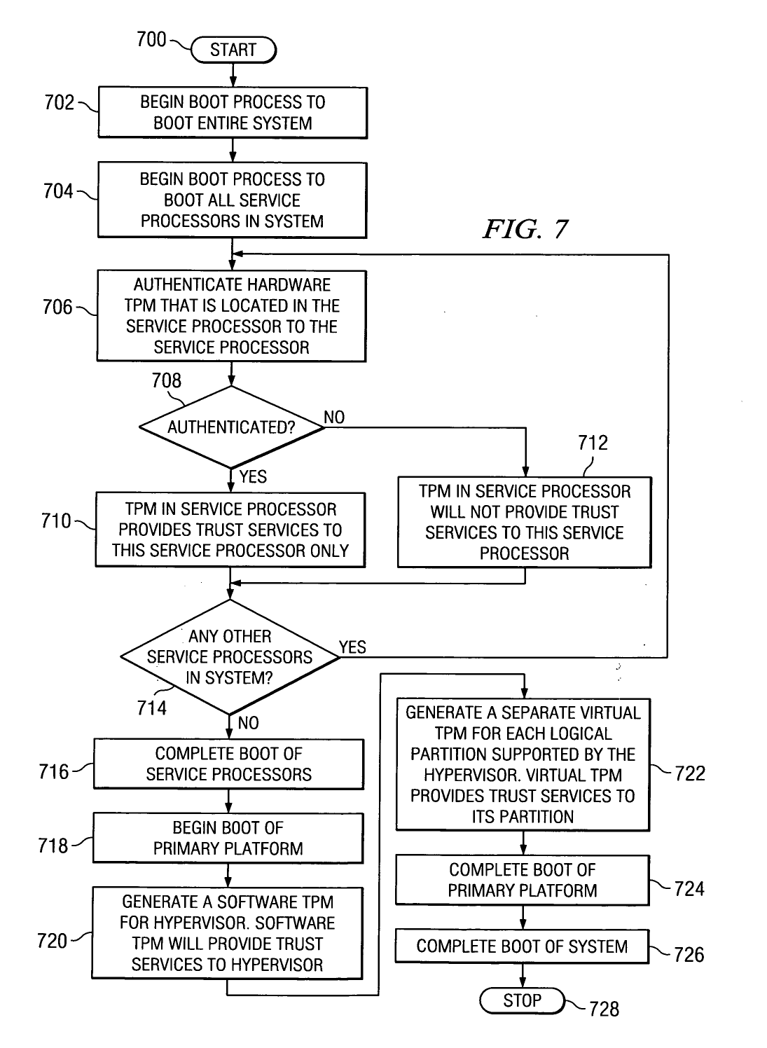

FIG. 7 depicts a high level flow chart that illustrates booting service processors and authenticating TPMs such that a TPM provides trust services just to the service processor in which the TPM is included in accordance with the present invention. The process starts as depicted by block 700 and thereafter passes to block 702 which illustrates beginning a boot process to boot the entire system. Next, block 704 depicts beginning the boot process to boot a service processor in the system. Thereafter, block 706 illustrates authenticating a hardware TPM that is physically located within a service processor to that service processor (SP).

Block 708 depicts a determination of whether or not the TPM was successfully authenticated to its SP. This step is described in more detail with reference to FIG. 6. If a determination is made that the TPM was successfully authenticated to its SP, the process passes to block 710 which illustrates the TPM in the SP providing its trust services to just this SP. The process then passes to block 714. Referring again to block 708, if a determination is made that the TPM was not successfully authenticated to the SP, the process passes to block 712 which depicts the TPM not being able to provide its trust services to this SP. The process then passes to block 714.

Block 714 depicts a determination of whether or not there are other service processors in the system. If a determination is made that there are other service processors in the system, the process passes back to block 706. Referring again to block 714, if a determination is made that there are no other service processors in the system, the process passes to block 716 which illustrates completing booting of the service processors. Thereafter, block 718 depicts beginning the boot process of the primary platform.

Next, block 720 illustrates generating a software TPM for the hypervisor. The software TPM will provide trust services to the hypervisor. The process then passes to block 722 which depicts generating a separate virtual, or logical, TPM for each logical partition that is supported by the hypervisor. Each virtual TPM provides trust services to its partition. Thereafter, block 724 illustrates completing the boot of the primary platform. Block 726, then, depicts completing the boot of the system. The process then terminates as illustrated by block 728.

It is important to note that while the present invention has been described in the context of a fully functioning data processing system. Those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. An apparatus for implementing a trusted computing environment within a data processing system, the apparatus comprising:
said system including a plurality of different service processor-based hardware platforms, each one of said platforms including a service processor; and
a plurality of different hardware trusted platform modules (TPMs), each one of said plurality of different TPMs providing trust services to only one of said service processor-based plurality of platforms, each one of said TPMs providing its trust services to only a portion of said data processing system.

2. The apparatus of claim 1, further comprising:
said system including a primary platform and a hypervisor that manages logical partitioning of said primary partition;
a software-based TPM associated with said hypervisor; and
said hypervisor for providing a virtual TPM utilizing said software-based TPM for each one of a plurality of logical partitions.

3. The apparatus of claim 1, further comprising:
each one of said service processor-based platforms including a separate hardware physical TPM physically located in said one of said platforms.

4. The apparatus of claim 1, further comprising:
each one of said plurality of TPMs including its own unique platform binding key;
said platform binding key that is stored in one of said plurality of TPMs being shared with one of said platforms in which said one of said plurality of TPMs is physical located.

5. The apparatus of claim 1, further comprising:
in response to a reboot of one of said platforms, said service processor attempting to verify itself using one of said plurality of TPMs that is physically located in said service processor that is located in said one of said platforms;
in response to said service processor successfully verifying itself, said one of said plurality of TPMs providing its trust services to said service processor; and
in response to said service processor unsuccessfully verifying itself, said one of said plurality of TPMs not providing its trust services to said service processor.

6. The apparatus of claim 5, further comprising:
an operating system kernel of said service processor being digitally signed to produce a kernel signature that is stored in said service processor during manufacturing of said service processor;
said kernel signature being hashed to produce a hashed kernel value that is stored in said service processor during manufacturing of said service processor;
service processor code of said service processor being digitally signed to produce a code signature that is stored in said service processor during manufacturing of said service processor; and
said code signature being hashed to produce a hashed code value that is stored in said service processor during manufacturing of said service processor.

7. The apparatus of claim 6, further comprising:
said service processor attempting to verify itself by:
said service processor retrieving from said service processor said kernel signature and providing said kernel signature to said one of said plurality of TPMs;
said one of said plurality of TPMs hashing said kernel signature to produce a second hashed kernel value;
said service processor retrieving from said service processor said code signature and providing said code signature to said one of said plurality of TPMs;
said one of said plurality of TPMs hashing said code signature to produce a second hashed code value;
said service processor comparing said hashed kernel value to said second hashed kernel value and comparing said hashed code value to said second hashed code value;
responsive to said hashed kernel value and said second hashed kernel value being the same values and said hashed code value and said second hashed code value being the same values, said service processor successfully verifying itself; and
responsive to said hashed kernel value and said second hashed kernel value being different values and said hashed code value and said second hashed code value being different values, said service processor unsuccessfully verifying itself.

8. A method in an apparatus for implementing a trusted computing environment within a data processing system, said method comprising:
including in said system a plurality of different service processor-based hardware platforms, each one of said platforms including a service processor; and
including in said system a plurality of different hardware trusted platform modules (TPMs), each one of said plurality of different TPMs providing trust services to only one of said service processor-based plurality of platforms, each one of said TPMs providing its trust services to only a portion of said data processing system.

9. The apparatus of claim 8, further comprising:
said system including a primary platform and a hypervisor that manages logical partitioning of said primary partition;
associating a software-based TPM with said hypervisor; and
providing, by said hypervisor, a virtual TPM utilizing said software-based TPM for each one of a plurality of logical partitions.

10. The method of claim 8, further comprising:
each one of said service processor-based platforms including a separate hardware physical TPM physically located in said one of said platforms.

11. The method of claim 8, further comprising:
including a unique platform key in each one of said plurality of TPMs;
sharing said platform binding key that is stored in one of said plurality of TPMs with one of said platforms in which said one of said plurality of TPMs is physical located.

12. The method of claim 8, further comprising:
rebooting said one of said platforms;
in response to a reboot of one of said platforms, attempting, by said service processor, to verify itself using one of said plurality of TPMs that is physically located in said service processor that is located in said one of said platforms;
in response to said service processor successfully verifying itself, providing trust services to said service processor by said one of said plurality of TPMs; and
in response to said service processor unsuccessfully verifying said itself, prohibiting said one of said plurality of TPMs from providing its trust services to said service processor.

13. The method of claim 12, further comprising:
digitally signing an operating system kernel of said service processor to produce a kernel signature that is stored in said service processor during manufacturing of said service processor;
hashing said kernel signature to produce a hashed kernel value that is stored in said service processor during manufacturing of said service processor;
digitally signing service processor code of said service processor to produce a code signature that is stored in said service processor during manufacturing of said service processor; and
hashing said code signature to produce a hashed code value that is stored in said service processor during manufacturing of said service processor.

14. The method of claim 13, further comprising:
attempting by said service processor to verify itself:
retrieving from said service processor, by said service processor, said kernel signature;
providing, by said service processor, said kernel signature to said one of said plurality of TPMs;
hashing, by said one of said plurality of TPMs, said kernel signature to produce a second hashed kernel value;
retrieving from said service processor, by said service processor, said code signature;
providing, by said service processor, said code signature to said one of said plurality of TPMS;
hashing, by said one of said plurality of TPMs, said code signature to produce a second hashed code value;
comparing, by said service processor, said hashed kernel value to said second hashed kernel value and comparing, by said service processor, said hashed code value to said second hashed code value;
responsive to said hashed kernel value and said second hashed kernel value being the same values and said hashed code value and said second hashed code value being the same values, determining, by said service processor, that said service processor was successfully verified; and
responsive to said hashed kernel value and said second hashed kernel value being different values and said hashed code value and said second hashed code value being different values, determining, by said service processor, that said service processor was not successfully verified.

15. A computer program product for implementing a trusted computing environment within a data processing system, said product including the data processing system implemented steps of:
instructions for including in said system a plurality of different service processor-based hardware platforms, each one of said platforms including a service processor; and
instructions for including in said system a plurality of different hardware trusted platform modules (TPMs), each one of said plurality of different TPMs providing trust services to only one of said service processor-based plurality of platforms, each one of said TPMs providing its trust services to only a portion of said data processing system.

16. The product of claim 15, further comprising:
said system including a primary platform and a hypervisor that manages logical partitioning of said primary partition;
instructions for associating a software-based TPM with said hypervisor; and
instructions for providing, by said hypervisor, a virtual TPM utilizing said software-based TPM for each one of a plurality of logical partitions.

17. The product of claim 15, further comprising:
instructions for including a unique platform key in each one of said plurality of TPMs;
instructions for sharing said platform binding key that is stored in one of said plurality of TPMs with one of said platforms in which said one of said plurality of TPMs is physical located.

18. The product of claim 15, further comprising:
instructions for rebooting said one of said platforms;
in response to a reboot of one of said platforms, instructions for attempting, by said service processor, to verify said service processor using one of said plurality of TPMs that is physically located in said service processor that is located in said one of said platforms;
in response to said service processor successfully verifying itself, instructions for providing trust services to said service processor by said one of said plurality of TPMs; and
in response to said service processor unsuccessfully verifying said service processor, instructions for prohibiting said one of said plurality of TPMs from providing its trust services to said service processor.

19. The product of claim 15, further comprising:
instructions for digitally signing an operating system kernel of said service processor to produce a kernel signature that is stored in said service processor during manufacturing of said service processor;
instructions for hashing said kernel signature to produce a hashed kernel value that is stored in said service processor during manufacturing of said service processor;
instructions for digitally signing service processor code of said service processor to produce a code signature that is stored in said service processor during manufacturing of said service processor; and
instructions for hashing said code signature to produce a hashed code value that is stored in said service processor during manufacturing of said service processor.

20. The product of claim 19, further comprising:
instructions for attempting, by said service processor, to verify itself:
instructions for retrieving from said service processor, by said service processor, said kernel signature;
instructions for hashing, by said one of said plurality of TPMs, said kernel signature to produce a second hashed kernel value;
instructions for retrieving from said service processor, by said service processor, said code signature;
instructions for hashing, by said one of said plurality of TPMs, said code signature to produce a second hashed code value;
instructions for comparing, by said service processor, said hashed kernel value to said second hashed kernel value and comparing, by said service processor, said hashed code value to said second hashed code value;
responsive to said hashed kernel value and said second hashed kernel value being the same values and said hashed code value and said second hashed code value being the same values, instructions for determining, by said service processor, that said service processor was successfully verified; and
responsive to said hashed kernel value and said second hashed kernel value being different values and said hashed code value and said second hashed code value being different values, instructions for determining, by said service processor, that said service processor was not successfully verified.
